(19) United States
(12) Patent Application Publication
(10) Pub. No.: US 2024/0053149 A1
(43) Pub. Date: Feb. 15, 2024

(54) METHOD AND DEVICE FOR GENERATING THE PATH OF A MOVING APPARATUS WITHIN A PREDETERMINED TIME CONSTRAINT

(71) Applicant: THALES, COURBEVOIE (FR)

(72) Inventors: Lionel GAYRAUD, PALAISEAU (FR); Pierre SAVEANT, PALAISEAU (FR)

(21) Appl. No.: 18/255,697

(22) PCT Filed: Dec. 2, 2021
(86) PCT No.: PCT/EP2021/084055

§ 371 Date: Jun. 2, 2023

(30) Foreign Application Priority Data
Dec. 4, 2020 (FR) FR2012674

(51) Int. Cl. G01C 21/20

(52) U.S. Cl. CPC G01C 21/20

(57) ABSTRACT

A method and device generate the path of a moving apparatus, within a predetermined time constraint, between a start and end points, the moving apparatus having predetermined movement constraints. The method includes: calculating a grid of a movement area of the mobile device, the start point and the end point belonging to the movement area, the grid being formed by a set of adjacent grid elements; calculating a cost map associating at least one cost value with each grid element; calculating, by a wavefront propagation method using the grid and the calculated cost map, a first integrated cost map associated with the point of departure and a second integrated cost map associated with the point of arrival; and determining a diverted path linking the points of departure and arrival via a detour point, using the first and second integrated cost maps.

The present invention relates to a method for generating a path of a moving apparatus, within a predetermined time constraint, between a point of departure and a point of arrival, said moving apparatus having predetermined movement constraints. The invention further relates to an associated device and an associated computer program product.

The invention is in the field of movement control of moving apparatuses, e.g. air, marine or submarine apparatuses, and more particularly the field of generating movement paths for the moving apparatuses within time constraints, also called synchronized paths.

For two separate moving apparatuses, two paths are said to be synchronized if the paths meet a time constraint, e.g. the arrival at the same point, called point of arrival, within a predetermined time range, or within predetermined successive ranges. Of course, the above can be generalized to any number of moving apparatuses greater than two.

For only one moving apparatus, synchronization consists of setting a range of arrival time, e.g. with respect to a target to be achieved, or, equivalently, a given range of path durations. Thereby, for each moving apparatus having movement constraints, e.g. a minimum movement speed and a maximum movement speed, or, in certain applications, a constant movement speed, it is necessary to generate a path of duration comprised within a range of path durations, to ensure synchronization at the point of arrival.

The invention finds particular application in the field of cooperative path planning for moving apparatuses, e.g. unmanned aircraft on board, for given missions. E.g., for a given mission, civil or military, unmanned aircraft have to reach a point of arrival in a time-coordinated manner, starting from separate points of departure. Alternatively, a plurality of moving apparatuses of different types are to be coordinated, e.g. moving apparatuses having different movement constraints (e.g. minimum speed, maximum speed).

In addition to the movement constraints, constraints relating to the possible routes are imposed, where such constraints might be due to natural conditions (reliefs, currents, weather) or to imposed external conditions (e.g. passage areas, areas to be avoided, zones to fly over).

A problem then consists of generating synchronized paths for all the moving apparatuses considered. In the particular case of a coordinated arrival at a point of arrival, synchronization takes into account the slowest moving apparatus. For the other apparatuses, a path of increased duration is calculated.

Scientific publications relating to the synchronization of moving apparatuses are known, describing in particular computational methods based on mathematical models, which generally require a long computation time or which generate paths which are too constrained topologically.

The subject matter of the invention is to remedy the drawbacks of the prior art.

To this end, according to one aspect, the invention proposes a method for generating a path for a moving apparatus, within a predetermined time constraint, between a point of departure and a point of arrival, said moving apparatus having predetermined movement constraints, the method being implemented by a processor of a programmable computing device. Such method includes the steps of:
calculating a grid of a movement area of the mobile device, the start point and the end point belonging to the movement area, the grid being formed by a set of adjacent grid elements,
calculating a cost map associating at least one cost value with each grid element,
calculating, by means of a wavefront propagation method using the grid and the calculated cost map, a first integrated cost map associated with the start point and a second integrated cost map associated with the point of arrival,
determining a detour path linking the point of departure and the point of arrival via a detour point, using the first and second integrated cost maps, the length of the determined detour path being compatible with the predetermined time constraint.

Advantageously, the method of the invention implements the calculation of a first integrated cost map associated with the point of departure, and a second integrated cost map associated with the point of arrival, and the maps can be used for the generation of diverted paths, within the time constraint, while being optimized according to a cost strategy. Advantageously, the generation of paths can be done in parallel, which is used for computational optimization.

The path generation method according to the invention can further have one or a plurality of the features below, taken independently or according to all technically feasible combinations:

The path determination comprises:
a selection of at least one candidate detour point, belonging to the movement area, and
a generation of a path linking the point of departure, the candidate detour point and the point of arrival using the said first integrated cost map for calculating a first half-path between the point of departure and the candidate detour point, and using said second integrated cost map for calculating a second half-path between the candidate detour point and the point of arrival, the generated path being formed by the joining of said first and second half-paths,
a verification of compatibility of the length of the generated path with said predetermined time constraint.

The method includes a repeat of the steps of selecting a candidate detour point and of generating a path for a plurality of candidate detour points according to a predefined delay strategy.

The first half-path is calculated by a gradient descent method so as to obtain the shortest path, as defined in the first integrated cost map, between the point of departure and the candidate detour point, and the second half-path is calculated by a gradient descent method so as to obtain the shortest path, in the sense of the second integrated cost map, between the candidate detour point and the point of arrival.

The wavefront propagation method uses an eikonal propagator.

The grid is a regular grid.

The grid is an irregular grid.

The grid is isotropic, with each grid element having an associated cost value or an analytical cost function.

The grid is anisotropic, at least one grid element has a plurality of associated cost values, depending on a direction of travel direction through said grid element.

A cost map is calculated by combining a plurality of initial cost maps according to a predetermined cost strategy.

The method further includes a step of determining a range of path lengths satisfying the time constraint and the movement constraints of the moving apparatus.

According to another aspect, the invention relates to a device for generating a path of a moving apparatus, within a predetermined time constraint, between a point of departure and a point of arrival, said moving apparatus having predetermined movement constraints, including a processor configured for using:
a module for calculating a grid of a movement area of the mobile device, the start point and the end point belonging to the movement area, the grid being formed by a set of adjacent grid elements,
a module for calculating a cost map associating at least one cost value with each grid element,
a calculation module using a wavefront propagation method using the grid and the calculated cost map of a first integrated cost map associated with the point of departure, and a second integrated cost map associated with the point of arrival,
a module for determining a diverted path linking the point of departure and the point of arrival via a detour point, using said first and second integrated cost maps, the length of the diverted path determined being compatible with said predetermined time constraint.

According to another aspect, the invention relates to a computer program including software instructions which, when implemented by a programmable electronic system, implement a method of path generation, as briefly described hereinabove.

Other features and advantages of the invention will be clear from the description thereof which is given below as a non-limiting example, with reference to the enclosed figures, among which:

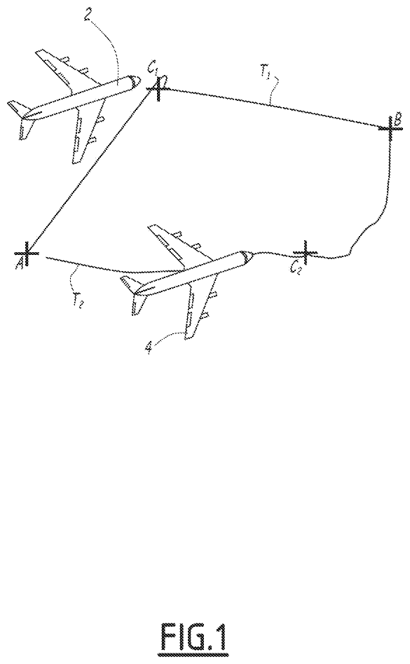

FIG. 1 is a schematic example of synchronized paths of moving apparatuses;

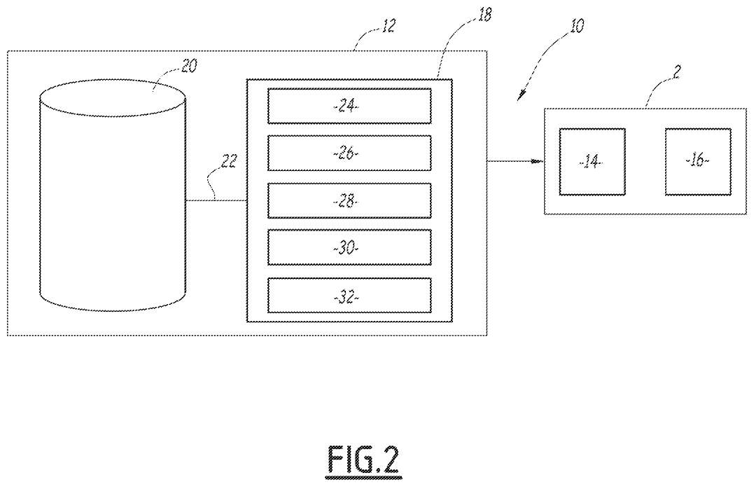

FIG. 2 is a moving apparatus guiding system comprising a time-constrained path generation device;

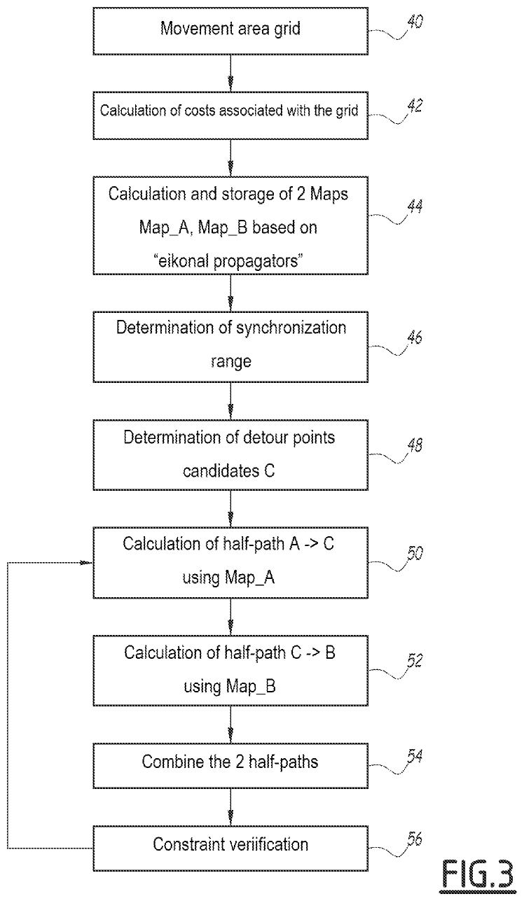

FIG. 3 is a flowchart of the main steps of path generation method according to one embodiment;

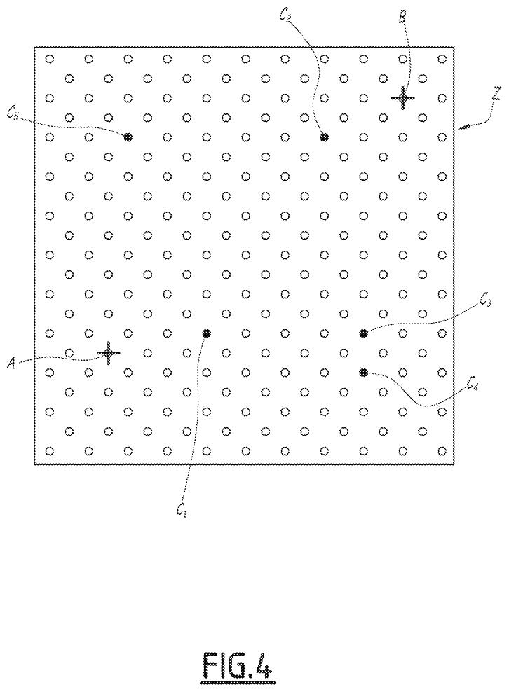

FIG. 4 is a schematic example of regular grid;

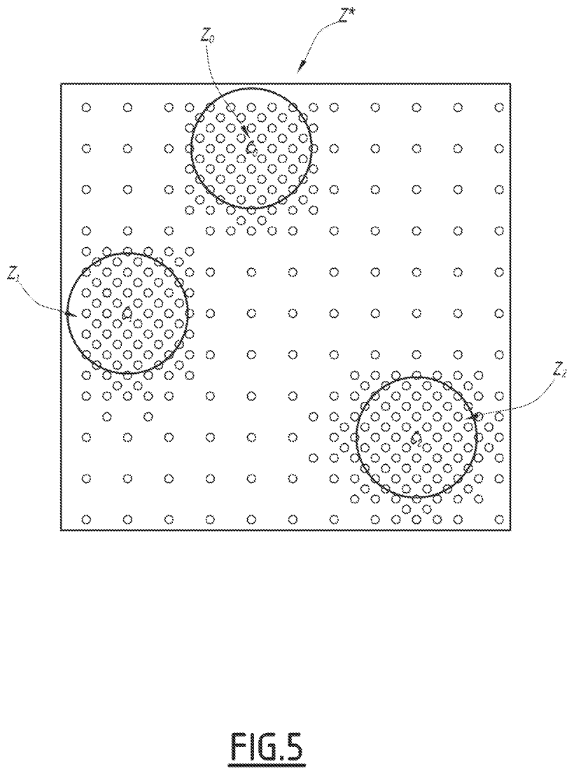

FIG. 5 is a schematic example of an irregular grid;

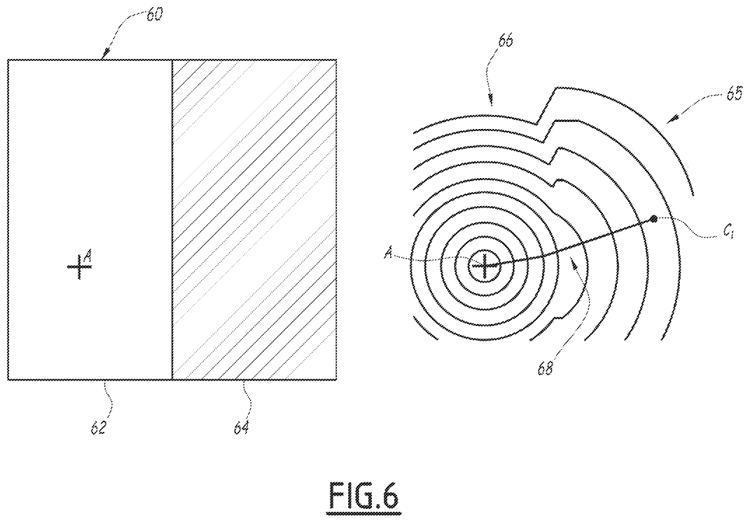

FIG. 6 is an example of a cost map and of an integrated cost map associated with the cost map.

FIG. 1 schematically shows a scenario of application of the invention. Two moving apparatuses 2, 4, e.g. unmanned aircraft, move from a point of departure A to a point of arrival B, with synchronization constraints.

It is understood that the invention is not limited to a particular type of moving apparatus, and finds applications for air, marine, submarine or land moving apparatuses. It is also understood that the invention is not limited to synchronizing such apparatuses to a single meeting point.

The path generation method is applied for each moving apparatus, the time constraints, in particular a path duration constraint, being applied to each moving apparatus, according to a mission to be carried out.

Each apparatus 2, 4 of the example shown in FIG. 1 moves along a calculated path T₁, T₂, passing through a detour point C₁, C₂ brought in for meeting a given time constraint, according to a method described in greater detail hereinafter. A path passing through a detour point is a diverted, or delayed path, in order to meet a given time constraint.

Hereinafter, the invention will be described with reference to only one moving apparatus, but it is understood that the method applies in a similar way to N moving apparatuses, where N is greater than or equal to 2.

FIG. 2 schematically illustrates an example of a guiding system 10 for a moving apparatus 2 wherein the invention is applied.

The moving apparatus 2 (shown in FIG. 1) is e.g. an aircraft, either with a pilot on-board or unmanned.

The moving apparatus has movement constraints, which are either due to mechanical or aerodynamic limitations, or due to limitations of acceptability for the pilot or for the mission carried out. The movement constraints include, in particular, a minimum and a maximum speed.

In the guiding system 10, the moving apparatus 2 receives guiding commands from a computing device 12. E.g., the computing device 12 is located in a ground computing center, and the guiding commands are communicated to the moving apparatus 2 via a wireless communication link. In a variant, the computing device 12 is on-board the moving apparatus 2.

The computing device 12 is configured for computing one or a plurality of paths according to the path generation method meeting a predetermined time constraint, described in greater detail hereinafter.

For example, path generation is performed as part of a mission planning of the moving apparatus 2, for collaborative planning with other moving apparatuses (not shown).

Mission planning involves taking into consideration many operational and environmental constraints.

Paths are said to be synchronized when the arrival at a point of arrival occurs within a predetermined time range.

Equivalently, the synchronization constraint is satisfied if, for a moving apparatus, the path of movement between a point of departure A and a point of arrival B has a duration T within a time range of given duration, e.g. comprised between Tₘᵢₙ and Tₘₐₓ, the moving apparatus having a speed between Vₘᵢₙ and Vₘₐₓ. The length of the corresponding path is within the range of lengths:

[Tₘᵢₙ×Vₘᵢₙ,Tₘₐₓ×Vₘₐₓ]. [MATH 1]

The computing device 12 is configured for generating a diverted (or delayed) path as a function of the given time constraint, and for sending guiding commands, according to the path obtained, to the moving apparatus 2.

A path is defined by a list of points to be crossed, the points being defined by spatial coordinates in a given spatial reference frame, and by a plot, e.g. which can be modeled by straight lines/curves, between the successive points.

The moving apparatus 2 comprises in particular an on-board computer 14 and a movement control system 16. E.g., the on-board computer 14 transforms the path into guiding commands, e.g. longitudinal acceleration commands, rudder movements, etc. which are sent to the movement control system 16.

The computing device 12 is e.g. a computer system consisting of one or a plurality of programmable electronic devices, i.e. computers.

To simplify the explanation, it is considered that the computing device 12 is a computer including a processor 18 and an electronic memory unit 20, suitable for communicating via a communication bus 22. The computation device 12 is configured for implementing the invention.

The processor 18 of the computing device 12 is configured for implementing a module 24 for meshing a movement area, a module 26 for computing a cost map associated with the grid, a module 28 for computing two integrated cost maps, including a first integrated cost map associated with the point of departure, and a second integrated cost map associated with the point of arrival, by applying a wavefront propagation method, a module 30 for determining one or a plurality of detour points and a module 32 for generating diverted path(s), each diverted path having a passage through a detour point.

The calculated grid, the cost map associated with the grid, the first integrated cost map associated with the point of departure, and the second integrated cost map associated with the point of arrival, are stored in the electronic memory unit 20.

The modules 24, 26, 28, 30 and 32 are suitable for cooperating, as described in greater detail hereinafter, for implementing a path generation method meeting a predetermined time constraint.

In one embodiment, the modules 24, 26, 28, 30, 32 are in the form of software instructions forming a computer program which, when executed by a computer, implements a path generation method according to the invention.

In a variant (not shown), the modules 24, 26, 28, 30, and 32 are each in the form of programmable logic components, such as FPGAs (Field Programmable Gate Array) microprocessors, GPGPU (General-purpose processing on graphics processing) components, or further in the form of dedicated integrated circuits, such as ASICs (Application Specific Integrated Circuit).

The computer program including software instructions is further apt to be recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM memory, a RAM memory, any type of non-volatile memory (e.g. EPROM, EEPROM, FLASH, NVRAM), a magnetic card or an optical card.

FIG. 3 is a flowchart of the main steps of an embodiment of a path generation method meeting a time constraint, implemented by a processor of a programmable computing device.

A path of a moving apparatus from a point of departure (point A) to a point of arrival (point B) is concerned. The spatial coordinates, in a predetermined reference frame, of the point of departure A and of the point of arrival B are supplied as input to the method and stored. The predetermined reference frame is a 2D or 3D reference frame.

The method includes a step 40 of calculating a grid of a movement zone, which includes the start points of departure and of arrival. The movement area is a 2D area defined in a plane or a 3D area defined in a 3-dimensional reference frame. The path of the moving apparatus will be defined by a set of points belonging to the movement area.

Meshing involves dividing the movement area into a set of adjacent grid elements, also called pixels.

The grid is e.g. a regular grid, the grid elements being squares or diamonds.

An example of regular grid of a movement area Z is shown in FIG. 4.

In a variant, a non-regular grid Z* as represented in FIG. 5 is generated, e.g. by applying the Maubach algorithm described in the article “Local Bisection Refinement for N-Simplicial grids generated by Reflection” by J M Maubach published in the SIAM Journal on Scientific Computing in 1995. The latter consists of locally refining a grid until a criterion on the local grid step is satisfied, the grid step being the distance between the centers of two adjacent pixels. In this way it is possible to concentrate the pixels in certain types of zones wherein it is desired to concentrate the precision of the calculations. E.g., zones Z₀, Z₁ and Z₂ with refined meshing are shown in FIG. 5.

The generation of the grid also depends on the choice of an associated cost strategy.

The generated grid is stored.

Returning to FIG. 2, the step 40 of meshing the movement zone is followed by a step 42 of calculating costs associated with the grid, consisting in associating a cost to each of the elements of the grid according to a given cost strategy.

The cost associated with the grid is chosen according to the application envisaged.

For example the cost is chosen as a function of a level of easiness or difficulty of movement in crossing each grid element, e.g. as a function of geographical or meteorological conditions (e.g. air currents, sea currents, type of ground) or external conditions (e.g. presence of roads or impassable zones, presence of obstacles or threats, etc.).

In one embodiment, the cost strategy is an isotropic strategy: the cost associated with a grid element does not depend on a direction of travel through said grid element, and the cost value associated with each grid element is fixed, e.g. a predetermined number or a number provided by an analytical function.

In another embodiment, the cost strategy is said to be anisotropic, the cost associated with a grid element also depends on a direction of travel through said element. In such case, a time derivative information is associated with each grid element. E.g., in one embodiment, the directions of travel are discretized, a set of directions of travel is defined, and a cost value or cost analytic function is associated with each discretized direction for a given grid element.

In one embodiment of the step 42, in an isotropic cost strategy, a number N of initial cost maps associated with the grid are obtained, and a cost map is obtained by combining the initial cost maps, e.g. by linear combination weighted by selected weighting coefficients. In a variant, the combination is obtained by using Choquet integrals, by inference on a fuzzy logic tree, or by any other known combination method.

For example, for an isotropic grid of a 2D movement zone, the following 2 initial cost maps are considered:
a first initial cost map wherein the cost k₁ is a function of the height of the ground, generated from a digital terrain model;
a second initial cost map wherein the cost k₂ consists of evaluating, for each pixel, an associated threat level.

The cost map is then generated by a linear combination of the initial cost maps, for each element of the grid (or pixel):

k=α₁×k₁+α₂×k₂ [MATH 2]

where α₁ and α₂ are selected values of weighting coefficients.

Advantageously, by varying the values of the weighting coefficients, a variety of cost maps is obtained, which makes it possible to increase the topological richness of the solutions provided, i.e. leads to obtaining paths of different shapes.

In the case of an anisotropic cost strategy, a similar combination is applied for generating cost maps.

The step 42 of calculating the costs associated with the grid is followed by a step 44 of calculating and storing two integrated cost maps, by means of a wavefront propagation method using eikonal propagators.

The eikonal propagators were developed to analytically solve the eikonal equation, which is the equation governing the path of light in a medium, and which is written as follows:

$$\\ \begin{matrix}\begin{matrix}\vert ∇ u ( x ) \vert = \frac{1}{f ( x )} , x ∈ Ω \\ u ( x ) = 0 , x ∈ \partial Ω\end{matrix} & [ MATH 3 ]\end{matrix}$$

The above equation was used to model movement, starting from a root point x₀, in a domain Ω, 2D or 3D, where x is a position in Ω, at speed f(x).

The domain Ω is discretized in the form of a grid.

The function f(x) defines a speed of movement, and the function u(x) defines the distance between the point x considered and the root point x₀.

In one embodiment of the invention, the cost function is the inverse of f(x): c(x)=1/f(x).

In such case, an eikonal propagator is an analytical solution for calculating, with respect to root point, x₀, an integrated cost map between x₀ and each point of the domain Ω, the values in the built-in cost map being dependent on the cost function associated with the points in the domain. In other words, an integrated cost map is analogous to a distance map in the sense of the applied cost function. In particular, the isometric curves are obtained, formed by all the points x of the domain Ω at an equal distance from x₀, in the sense of the cost function associated with the points of the domain.

A plurality of methods of analytic resolution of the eikonal equation have been proposed.

In particular, the method known as “Fast marching” was proposed in the article “A Fast Marching Level Set Method for Monotonically Advancing Fronts” by J. A. Sethian, 1996.

Said method is e.g. applied for the implementation of the step 44.

In a variant, any method for solving the eikonal equation, suitable for meshing the movement zone, 2D or 3D, is applicable.

During the step 44, the calculation of integrated cost maps comprises:
the calculation of a first integrated cost map associated with the point of departure A, i.e. having point A as the root point of departure, is performed, using the cost map calculated during the step 42;
the calculation of a second integrated cost map associated with the point of arrival B, i.e. having point B as the root point of arrival, is performed, using the cost map calculated during the step 42;

For example, in the case of a regular and isotropic 2D grid, the fast-marching method proposed by J. A Sethian is applied for calculating the first integrated cost map and the second integrated cost map.

The first integrated cost map and the second integrated cost map are stored.

The step 44 of calculating integrated cost maps is followed by a step 46 of determining a synchronization range, according to an imposed time constraint. Said step consists of calculating the minimum and maximum lengths of the or each path to be calculated, between the point of departure A and the point of arrival B.

The temporal constraint is an external constraint, depending on the application wherein the method is implemented.

The calculated path lengths also depend on the movement constraints specific to the moving apparatuses concerned, e.g. the average speed or the minimum and maximum speeds.

For example, the range of lengths given by the formula [MATH 1] is calculated during the step 46.

The method then includes a step 48 of determining candidate detour points, according to a delay strategy.

The candidate detour points are points in the movement zone.

For example, in one embodiment, according to a delay strategy, a regular grid, having an associated grid step, of candidate detour points, is tested.

In a variant, according to another delay strategy, a multi-resolution strategy is applied, starting from a regular grid with a first step, and iterating the search in zones of interest, forming on said zones a regular grid with a second step, finer than the first step, e.g. divided by two, and so on.

Considerations related to the application can also be taken into account, e.g. the choice of a detour point in an area of particular interest for the mission to be carried out, e.g. for taking pictures, or on the contrary, the choice of a detour point which could be a decoy for a third-party observer.

The candidate detour points are tested for determining detour points Cⱼ for which a path calculated between the point of departure A and the point of arrival B, passing through the point Cⱼ, has a length and a duration compatible with the time constraint. The length of the path depends on the length of the path and the speed of the moving apparatus. The compatibility with the time constraint is verified if the length of the path meets the constraint defined by the formula [MATH 1].

For each candidate detour point Cⱼ, the steps 50 to 56 described hereinafter are implemented for generating a diverted path and verifying the compatibility with the time constraint.

The path, called diverted path, is generated using the first integrated cost map and the second integrated cost map calculated and stored during the step 44: a first half-path between point A and point Cⱼ is calculated (step 50) using the first integrated cost map; a second half-path between point Cⱼ as the point of departure and point B as the point of arrival is calculated (step 52) using the second integrated cost map; the first and second half-paths are combined (step 54) to form a full path between A and B, passing through Cⱼ.

Each of the half-paths is calculated as being the shortest path in the sense of the integrated cost over the entire path on the integrated cost map considered, said path being formed orthogonally to the isometric curves, by a gradient descent method.

The complete diverted path is a combination of the two half-paths calculated by a gradient descent method.

The step 54 is followed by a step 56 of verifying of the length criterion.

A candidate detour point Cⱼ is retained if the effective length of the full diverted path between A and B, passing through Cⱼ, is within the range of lengths considered. The effective length is the distance to be traveled, in a unit of distance (meters or km) along the computed path.

For example, the verification 56 consists of verifying that the length of the path diverted through Cⱼ satisfies the relation [MATH 1], which is equivalent to a path duration which satisfies the temporal constraint.

The steps 50 to 56 are iterated over the detour candidate points tested.

The paths thus generated with detour points retained during the step 56 are all in accordance with the time constraint imposed, i.e. the lengths thereof fall within the range of lengths considered.

Thereafter, for application reasons, e.g. mission planning, it is possible to choose only one or a subset of the calculated diverted paths.

As a simplified example, FIG. 6 schematically illustrates a cost map 60, having two subparts 62 and 64, each subpart having a different associated cost, e.g. the subpart 62 having a cost of 2 per grid element (not shown in FIG. 6), and subpart 64 having a cost of 1 per grid element. E.g., a cost of traveling through each grid element is concerned, the subpart 62 corresponding to a snow-covered area, the subpart 64 to a snow-free area.

The first integrated cost map 66 calculated with the point A as a point of departure, as a function of the cost map 60, is illustrated schematically. Same comprises isometric curves 65, i.e. curves of points equidistant from point A in the sense of the cost map 60.

A detour point C₁ and a half-path 68 drawn between A and C₁, which is the shortest path between A and C₁ in the sense of the first integrated cost map, are also shown.

Advantageously, the paths generated are continuous and optimal by half-paths.

Advantageously, the proposed method can be used for generating paths meeting a given time constraint without varying the speed of the moving apparatuses. The above is of great practical interest in applications wherein it is not conceivable to slow down a moving apparatus, for technical reasons (e.g. minimum flight speed imposed) or for contextual reasons (e.g. vulnerability in the case of military moving apparatuses).

Advantageously, the method makes it possible to choose a cost strategy and to freely choose a set of detour points, according to contextual and application criteria.

Advantageously, a wide variety of cost maps can be tested, which makes it possible to compare a large number of scenarios, e.g. in mission planning.

Finally, advantageously, the calculations of the integrated cost maps are carried out only once, the maps being reused for testing any number of detour points, which leads to fewer calculations, and thus to an optimization of the calculation time. Moreover, the test of detour points and the calculation of paths are steps which can performed in parallel, which leads to massively reducing the calculation time.

1. A method for generating a path of a moving apparatus, meeting a predetermined time constraint, between a point of departure and a point of arrival, the moving apparatus having predetermined movement constraints, the method being implemented by a processor of a programmable computing apparatus, the method comprising:
calculating a grid of a movement zone of the moving apparatus, the point of departure and the point of arrival belonging to the movement zone, the grid being formed by a set of adjacent grid elements,
calculating a cost map associating at least one cost value with each grid element,
calculating, by means of a wavefront propagation method using the grid and the calculated cost map, a first integrated cost map associated with the point of departure and a second integrated cost map associated with the point of arrival,
determining a diverted path linking the point of departure and the point of arrival via a detour point, using the first and second integrated cost maps, the length of the determined diverted path being compatible with the predetermined time constraint.

2. The method according to claim 1, wherein the path determination comprises:
selecting at least one candidate detour point, belonging to the movement zone, and
generating a path linking the point of departure, the candidate detour point and the point of arrival using the said first integrated cost map for calculating a first half-path between the point of departure and the candidate detour point, and using said second integrated cost map for calculating a second half-path between the candidate detour point and the point of arrival, the generated path being formed by the joining of said first and second half-path,
verifying a compatibility of the length of the generated path with the predetermined time constraint.

3. The method according to claim 2, including a repeat of selecting a candidate detour point and of generating a path for a plurality of candidate detour points according to a predefined delay strategy.

4. The method according to claim 2, wherein said first half-path is calculated by a gradient descent method so as to obtain the shortest path, in the sense of the first integrated cost map, between the point of departure and the candidate detour point, and said second half-path is calculated by a gradient descent method so as to obtain the shortest path, in the sense of the second integrated cost map, between the candidate detour point and the point of arrival.

5. The method according to claim 1, wherein the wavefront propagation method uses an eikonal propagator.

6. The method according to claim 1, wherein the grid is a regular grid.

7. The method according to claim 1, wherein the grid is an irregular grid.

8. The method according to claim 1, wherein the grid is isotropic, each grid element having an associated cost value or an associated analytical cost function.

9. The method according to claim 1, wherein the grid is anisotropic, wherein at least one grid element has a plurality of associated cost values according to a direction of travel through the grid element.

10. The method according to claim 1, wherein the cost map is calculated by combining a plurality of initial cost maps according to a predetermined cost strategy.

11. The method according to claim 1, further comprising determining a range of path lengths satisfying the time constraint and the movement constraints of the moving apparatus.

12. A computer program including software instructions which, when executed by a programmable electronic system, implement a method for path generation according to claim 1.

13. A device for generating a path of a moving apparatus, meeting a predetermined time constraint, between a point of departure and a point of arrival, the moving apparatus having predetermined movement constraints, including a processor configured for implementing:
a calculating module which calculates a grid of a movement zone of the moving apparatus, the point of departure and the point of arrival belonging to the movement zone, said grid being formed by a set of adjacent grid elements,
a calculating module which calculates a cost map associating at least one cost value with each grid element,
a calculating module which calculates, by means of a wavefront propagation method using the grid and the calculated cost map, a first integrated cost map associated with the point of departure, and a second integrated cost map associated with the point of arrival,
a determining module which determines a diverted path linking the point of departure and the point of arrival via a detour point, using said first and second integrated cost maps, the length of the diverted path determined being compatible with said predetermined time constraint.
